(19) United States
(12) Patent Application Publication
(10) Pub. No.: US 2007/0192420 A1
(43) Pub. Date: Aug. 16, 2007

(54) Method, apparatus and system for a keyed email framework

(76) Inventor: Robert L. Vaughn, Albuquerque, NM (US)

Correspondence Address: INTEL CORPORATION;c/o INTELLEVATE, LLC, P.O. BOX 52050, MINNEAPOLIS, MN, 55402, US

(21) Appl. No.: 11/355,476

(22) Filed: Feb. 15, 2006

(51) Int. Cl. G06F 15/16

(52) U.S. Cl. 709/206

(57) ABSTRACT

A method, apparatus and system provide a keyed email address (“KEA”) framework designed to reduce SPAM. In one embodiment, a recipient's email server may generate and/or allow the recipient to generate and maintain various keys to authenticate incoming email for the recipient. These keys may be manually or automatically provided to various authorized entities. These entities may thereafter send email to the recipient, including the key, and the recipient's email account may verify the key as authentic and thereafter associate the key uniquely with the incoming email address or domain. Thereafter, if an incoming email includes this key, the email address or domain of the incoming email will also be checked to determine whether the email address matches the assigned key. If not, the email may be tagged as suspicious or potential SPAM. Incoming emails without keys and/or that do not respond to requests for keys may also be tagged as potential SPAM.

### BACKGROUND

The term “SPAM” is typically used to refer to unsolicited electronic junk mail (e.g., advertisements) or junk newsgroup postings. An email address may be safe from SPAM as long as it is never used or given out to anyone. Unfortunately, the effective use of email requires that email addresses be given out or distributed to many different people, companies, organizations and web sites. Additionally, even when the email address is not voluntarily provided, there are various ways in which an email address may be “leaked out” onto the Internet (e.g., attached to web pages, purchased email lists, hackers, etc.) As a result of this distribution, most people are subject to SPAM, which may be not only be annoying and a waste of time, it may additionally be offensive, contain malicious code and/or spoof legitimate email. SPAM may also consume significant network bandwidth, thus slowing down enterprise operations.

Given the public nature of the Internet, attempts to reduce and/or eliminate SPAM have proven to be difficult. In the absence of an industry standard, online services, for example, have independently instituted various schemes to reduce and/or prevent SPAM. These conventional SPAM reduction systems typically work in one of two ways. First, SPAM filtering systems may filter out email that the system identifies as SPAM. These systems tend to not be very effective because SPAM authors are able to easily figure how these systems work and write SPAM messages that can bypass or fool the filters. An alternate scheme may be based on sender authentication. This scheme is designed to reduce SPAM by verifying that an email was actually sent from the email address that it appears to be from. Again, these schemes have proven to be largely ineffective because SPAM authors may easily set up authentic email addresses that nonetheless generate unwanted and unsolicited emails.

### BRIEF DESCRIPTION OF THE DRAWINGS

The present invention is illustrated by way of example and not limitation in the figures of the accompanying drawings in which like references indicate similar elements, and in which:

FIG. 1 illustrates an embodiment of the present invention;

FIG. 2 is a flow chart illustrating an embodiment of the present invention;

FIG. 3 illustrates an embodiment of the present invention;

FIG. 4 is a flow chart illustrating an embodiment of the present invention; and

FIG. 5 is a flow chart illustrating how an embodiment of the present invention may handle unsolicited and unauthorized emails.

### DETAILED DESCRIPTION

Embodiments of the present invention provide a method, apparatus and system for a keyed email framework. More specifically, embodiments of the invention provide a keyed email address (“KEA”) framework that is designed to reduce SPAM through the protection of email addresses. Hereafter, any reference to KEA shall include email accounts that recognize and/or are capable of generating unique keys for email addresses. The term “key”, as used herein does not refer exclusively to public/private encryption keys as are well known in the art, but may be used more broadly to include any string of characters (numbers and/or letters) and/or words (or any combination thereof) generated by the user and/or the user's email account. A string may refer to one or more characters and/or words. Additionally, the term “email address” as used herein shall include individual email addresses (e.g., user100@kea.com) as well as domains (e.g., all email addresses ending with kea.com). Reference in the specification to “ one embodiment” or “an embodiment” of the present invention means that a particular feature, structure or characteristic described in connection with the embodiment is included in at least one embodiment of the present invention. Thus, the appearances of the phrases “in one embodiment,” “according to one embodiment” or the like appearing in various places throughout the specification are not necessarily all referring to the same embodiment.

According to embodiments of the present invention, a KEA framework enables email addresses to be associated with unique information (hereafter referred to as “keys”) that “authenticate” the email address to the recipient. As previously described, keys may include any string of characters (numbers and/or letters) and/or words (or any combination thereof). Since the keys are uniquely associated with the sender's email address and are not valid for more than one email address, the keys provide a scheme for uniquely identifying and authenticating the sender. The KEA framework may be implemented such that varying levels of security are in place, depending on the level of interaction the user is willing to have. Thus, for example, in one embodiment, the scheme may automatically reject all but keyed emails (i.e., emails that include valid keys) while in alternate embodiments, the user may interact with the KEA scheme to authorize opening of some unkeyed emails (i.e., emails that do not include keys and/or emails that include invalid/expired keys). Additionally, in one embodiment, the user's email account may be configured to automatically generate keys while in other embodiments, the user may interact with the KEA scheme to generate the keys.

Embodiments of the present invention may be implemented in hardware, software, firmware or any combination thereof. In one embodiment, a KEA software module may be implemented within the recipient's email system as the enforcement mechanism. Embodiments of the present invention may be enforced by the recipient at various levels, e.g., at an enterprise level, group level and/or individual device level. If implemented at an enterprise level, the key enforcement mechanism described in further detail below may be enforced by one or more servers (e.g., email servers on the network) such that end users in the enterprise have little to no interaction with unauthorized emails. If, for example, a corporation determines that only validly keyed emails may be delivered to recipients, the end users within the enterprise may never “see” other unkeyed emails (assumed to be SPAM). If, on the other hand, the key enforcement mechanisms are implemented at a group and/or individual device level, the end users may have more interaction with all emails, keyed or otherwise. An important aspect of these various embodiments is the flexibility it provides to users and/or administrators.

For the purposes of explanation herein, the following description assumes that the KEA framework is implemented at a device level. In other words, regardless of where the device is located (at home, within an enterprise, etc.), the KEA framework may be implemented directly on the device. Thus, in one embodiment, a device having the KEA framework may automatically generate and maintain a list of keys for the recipient. These keys may be generated in a batch at predetermined times and/or be generated “on-the-fly”, as the need for the key arises. Since keys may comprise any string of characters (numbers and/or letters) and/or words (or any combination thereof), instead of the typically cryptic, meaningless strings generated as keys by public/private authentication schemes, embodiments of the present invention may also utilize recognizable strings of characters (numbers and/or letters) and/or words. This feature significantly enhances the usability of the embodiments of the invention by enabling users to select strings and/or words that are memorable or logical. For example, if the user desires to hand out a key to an acquaintance in San Francisco named Bob, the user may generate a new key using Bob's name and San Francisco in the string (e.g., SFBob). The user's email account may be configured to similarly generate and assign keys (e.g., including names and/or other logical identifiers within the keys to easily distinguish them).

Regardless of how they are generated, these keys may be distributed in a number of ways. In one embodiment, for example, the recipient's email account may include a KEA framework and the recipient may manually provide a key to a person or entity. According to this embodiment, the recipient's email account may examine all incoming emails for keys. If it finds a key (since the person has a key provided by the recipient), it may then check the key against the list of valid keys. In the event the key matches a valid key, the incoming email address of the person/entity may be automatically recorded as being uniquely associated with the key.

Alternatively, in other embodiments, the user may not provide a key to anyone or the entity to whom the key was provided may forget to enter the information in the email. In this example, when an email message is received and the recipient's email account examines the email for a key, no key may be found. Failing to find one, the email account may be configured to act in a variety of ways. In one embodiment, the email account may send a response to the sender, requesting a key. If the sender has a key (e.g., if he/she forgot to enter it in the original email), he/she may enter it at that point and the email may be returned to the recipient's email server. The key may then be verified by checking against the list of valid keys and thereafter, the email address may be associated with the key uniquely. In another embodiment, the user may simply not have a key and may return the email indicating the lack of a key. According to this embodiment, if the sender returns the email to the recipient, regardless of whether the sender has a key, the recipient's email account may now be assured that the email was sent from a real email account rather than a “spoofed” account. At this point, in one embodiment, the recipient's email system may be configured to either give the recipient the option of opening/accepting the email anyway (despite the lack of a key) or of automatically rejecting the email. It will be readily apparent to those of ordinary skill in the art that the behavior of the email account upon determining a lack of receipt is easily configurable based on the recipient's desires, without departing from the spirit of embodiments of the present invention.

Thus, according to the embodiments described above, each key is uniquely tied to an email address. Once associated with an email address, the key may no longer be used by another email address. If the key is stolen, for example, the thief (potential spammer) may attempt to use the key to send email to the recipient. On the receiving end, however, since the key is already known to be uniquely associated with a different email address, the incoming email may be flagged as potential SPAM. Importantly, embodiments of the present invention provide users with an accurate scheme to flag potential SPAM without having to interact with the unsolicited emails. In other words, once flagged as SPAM, embodiments of the invention enable users the freedom to configure their email accounts to automatically handle potential SPAM.

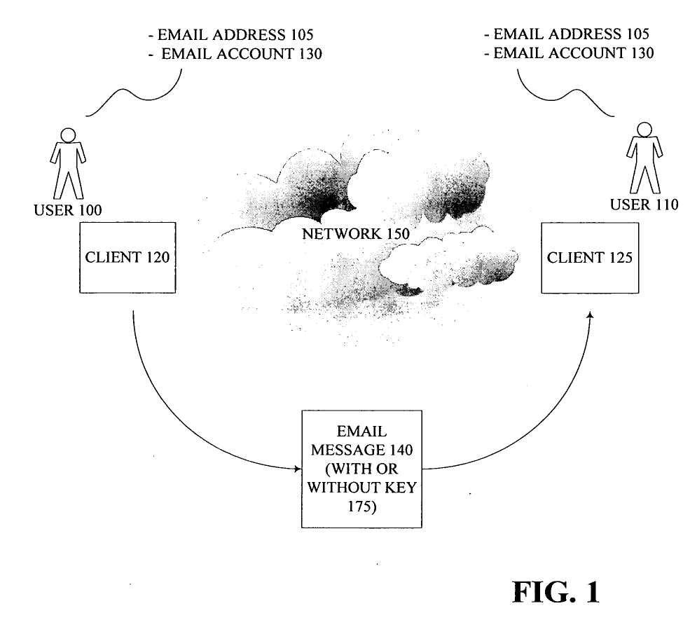

FIG. 1 illustrates conceptually a KEA scenario according to embodiments of the present invention. As illustrated, a user (“User 100”) having a first email address (“Email Address 105”) may desire to communicate with a second user (“User 110”) having a second email address (“Email Address 115”). Email Address 105 and Email Address 115 may each be running on the same or different types of email accounts without departing from the spirit of embodiments of the present invention. Thus, in various embodiments, the email accounts may include Microsoft Outlook accounts, Eudora accounts, web-based accounts and/or any POP-compliant email accounts. According to an embodiment of the invention, User 110's email account (“Email Account 135”) is assumed to be KEA enabled, i.e., it is capable of generating and/or recognizing unique keys, while User 100's email account (“Email Account 130”) may or may not be KEA enabled. Additionally, for the purposes of explanation, User 100 is assumed to be using a first computing device (“Client 120”) communicatively coupled to User 110 on a second computing device (“Client 125”) via a network (“Network 150”). According to embodiments of the present invention, a unique key (“Key 175”) may be associated with Email Address 105 such that Client 125 may process the key to recognize that Email Address 105 is from Client 120.

According to embodiments of the present invention, Key 175 may be associated with Email Address 105 in a number of different scenarios. In a first scenario, User 100 may not have (or know of) Key 175, i.e., Email Account 130 may not be KEA enabled or User 100 may simply not have a unique key for User 110. In an alternate scenario, User 110 may have provided User 100 with Key 175 to include in any emails sent from Email Address 105. In this scenario, Email Account 130 may or may be KEA enabled. In yet another scenario, User 100 may have Key 175 (either previously provided by User 110 or previously acquired otherwise) but the key may have expired. In this final scenario, both Email Account 130 and/or Email Account 135 may be KEA enabled. Each of these scenarios is discussed in further detail below.

In the first scenario, User 100 may not have or know of Key 175. Nonetheless, User 100 may send an email message (“Email Message 140”) to User 110 if he or she knows that User 10's email address is Email Address 105. Email Message 140 from Email Address 105 may be transmitted from User 100's mail server to User 10's mail server. As previously mentioned, User 10's email account (Email 135) is assumed to be KEA enabled. Accordingly, upon receipt of the email from Email Address 105, Email Account 135 may examine the email for a key. If a key is present in Email Message 140, Email Account 135 may compare the key to a list of stored keys to determine whether it is a valid key for Email Address 105. In the present example, however, since User 100 does not have or know of Key 175, Email Message 140 does not include a key.

Upon determining that Email Message 140 does not include a key, Email Account 135 may return Email Message 140 to Email Account 130 and request a key from User 100. In one embodiment, a checksum value may be added to Email 140 when it is returned to Email Account 130 to avoid spoofing. The use of checksums is well known in the art and further description thereof is omitted herein in order not to unnecessarily obscure embodiments of the present invention. User 100 may receive returned Email 140 and reply that he or she does not have a key. Email 140 may then be re-delivered to Email Account 135.

In one embodiment, upon receipt of re-delivered Email 140, Email Account 135 may examine the email and determine that it still does not include a key. Email 140 may thus be flagged an “unkeyed” email and User 110 may elect to reject the email or take a chance and open it anyway. Since User 100 responded to the request for a key (albeit to inform User 110 that he or she did not have a key), User 110 may deem the email “safe” to open, to determine its contents. Although this email may in fact be SPAM, the fact that User 110 received a response significantly reduces the chances of it being SPAM because most spammers typically set up automated mailing schemes that are incapable of interacting with the recipient. On the other hand, if Email Account 135 returns Email 140 to the sender and receives no reply, Email Account 135 may safely deem the email SPAM and delete it from the user's inbox. In one embodiment, in the event no response is received, Email Account 135 may additionally flag Email Address 105 to filter potential SPAM in the future.

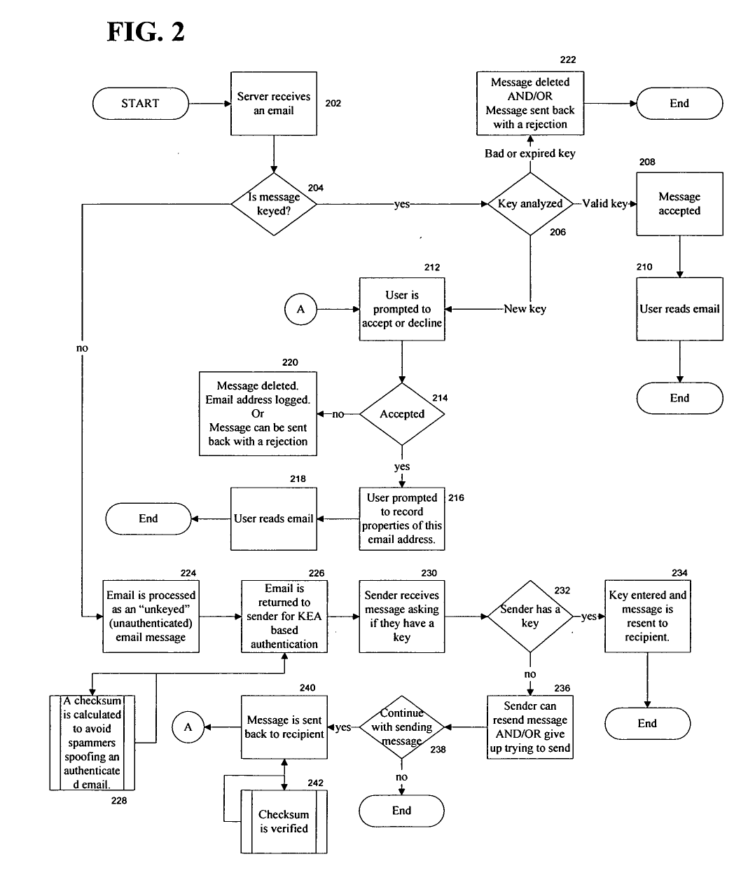

FIG. 2 is a flow chart illustrating an embodiment of the present invention. Although the following operations may be described as a sequential process, many of the operations may in fact be performed in parallel and/or concurrently. In addition, the order of the operations may be re-arranged without departing from the spirit of embodiments of the invention. The following scheme may be implemented on a variety of mail systems, including web-based mail systems. As illustrated, a server may receive an email in 202 and in 204, the email message may be examined to determine whether the message is keyed (i.e., whether it includes a unique key). If it does include a key, the key may be analyzed in 206 and if the key matches a valid key (e.g., in a list of keys deemed valid), the email message may be accepted by the email server in 208 and the user may open the email in 210 without any additional precautions.

If, however, the email message does include a key but the key does not match a valid key, the recipient may be prompted to accept or decline the email in 212. If the user accepts the email in 214, the user may be prompted in 216 to record the properties of the email address. The user may thereafter read the email in 218. If, on the other hand, the user declines the email in 214, the email message may be deleted in 220 and/or a message may be sent to the email sender rejecting the email. And finally, if the key analyzed in 206 matches a key in the list of keys, but has expired (or otherwise been deactivated), the email message may be deleted in 222.

Alternatively, if the message does not include a key in 204, the mail may be processed as an “unkeyed” email message in 224 and returned to the sender in 226 with a request to provide a key. A checksum value may be calculated in 228 prior to sending the email. In 230, the sender may receive a message requesting a key and if the sender has a key in 232, the sender may enter the key in the message and resend the email to the recipient in 234 (to be processed according to the process described above). If, on the other hand, sender does not have a key, the sender may delete the email in 236 or resend the message without a key. If the sender continues with resending the message in 238, the message may be sent back to the recipient in 240 and the checksum (previously calculated in 228) in the message may be verified to authenticate the email. The use may again be prompted to accept or decline the email in 212 and the process may repeat itself.

According to embodiments of the invention, the KEA framework may be implemented in a variety of ways. In one embodiment, only the recipient may be “KEA compliant”, i.e., the recipient may independently establish a KEA framework, regardless of whether any of the senders have implemented the framework. This provides the recipient with a significant amount of flexibility to protect itself, even if others on the network are not KEA compliant. Thus, for example, the recipient's email server (Email Account 135 on Client 125 in the example above), may include a KEA framework (e.g., implemented as an email client plug-in) capable of generating unique keys and maintaining a list of unique keys to enforce the KEA scheme described above, regardless of whether other clients on the network recognize the KEA scheme. In an alternative embodiment, the KEA framework may be implemented on an enterprise level, such that all clients within an enterprise network are KEA aware. In yet another embodiment, the server may be a web-based server.

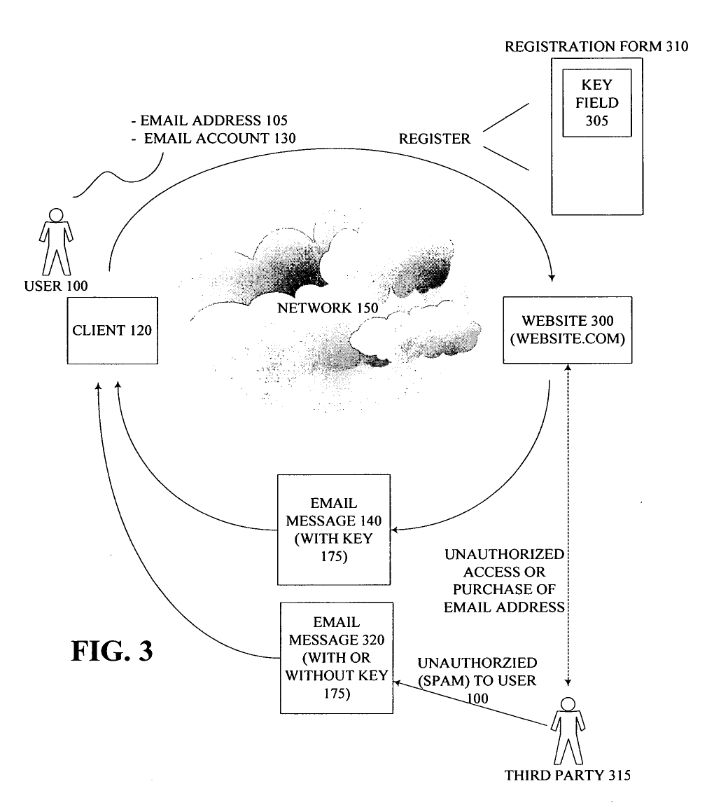

FIG. 3 illustrates a further embodiment of the present invention. As illustrated, User 100 may desire to register with a third part website (“Website 300”) to create an account on a retail website, to sign up for an event, etc. Currently, despite assurances otherwise, users have no way of ensuring that the email address they provide is not thereafter used for unauthorized purposes and/or provided to (or acquired by) unauthorized parties.

According to embodiments of the present invention, if Website 300 implements a KEA framework, User 100 may ensure that a unique key (“Key 175”) is associated with his/her email (“Email Address 105”) during registration, such that any email generated from this website address to Email Address 105 requires Key 175 in order to be authenticated. Thus, for example, during registration, User 100 may be required to fill in an extra text field (“Key Field 305”) in the registration form (“Registration Form 310”). In one embodiment, Key Field 305 may include a key phrase (e.g., text and/or numbers) that may be used as Key 175 and is unique for Website 300. According to this embodiment, instead of providing Key 175 for use by only a single email address, Key 175 may be associated with the Website address (i.e., any email generated from this website's address may be authenticated by User 100 with Key 175). In one embodiment, User 100 may capture this information on his/her email account (“Email Account 130”), either manually or automatically (e.g., via a modified web browser capable of capturing and maintaining this information). The information captured essentially informs Email Account 130 that if any emails originate from Website 300's email address, addressed to Email Address 105, and if the emails include Key 175, then the email is authorized.

Thereafter, any emails originating from Website 300's address to User 100 may automatically include Key 175. Thus, if/when Website 300 generates any emails to Email Address 105, (e.g., a confirmation email or notification of product shipment), the email (“Email 315”) may include Key 175, which enables Email Account 130 to verify and authenticate the source of the email (e.g., by examining the list or database of keys and email addresses maintained by Email Account 130). Since Email 115 originates from Website 300's address and includes Key 175, upon checking against its stored information, Email Account 130 may thereafter authenticate the email and enable User 100 to view the email.

If, however, Website 300's operator proves to be unscrupulous and “sells” the email list from the website and/or Website 300 is hacked by hackers (hereafter third party and/or hackers referred to collectively as “Third Party 315”), User 100 no longer has to deal with the hassle and inconvenience of determining this manually. Instead, according to embodiments of the present invention, even if the unauthorized email includes Key 175, Email Account 130 may nonetheless reject the email. Specifically, although Key 175 itself is a “valid” key, it is only valid for Website 300's address. Thus, although Third Party 315 may obtain User 100's email address and even an authorization key for this email address, emails from Third Party 310 (illustrated as “Email Message 320”) may still be flagged as SPAM because the authorization key and website address do not match the list maintained by Email Account 130.

According to the embodiment described above, any user from Website 300 may be authorized to send email to User 100 (and the email may automatically include Key 175). Thus, for example, regardless of the email address (e.g., sales@website300.com, productinfo@website300.com, etc.), since Website 300's address is authorized as a whole, any emails on that domain (i.e., website300.com) may be delivered to Email Account 130 and validated. This provides the operator of Website 300 the flexibility to send email to User 100 from various email accounts within the company.

In alternate scenarios, Website 300 may implement embodiments of the invention more stringently, e.g., by enabling Key 175 to authenticate only emails from custservice@website300.com (or only emails from selected email addresses User 100 may authorize during registration). This ensures that User 100 may not receive additional solicitation other than the ones that the user elected during the registration process. Website 300 may deem this an important feature to highlight to customers, to encourage customers to register without being bombarded thereafter with emails from Website 300.

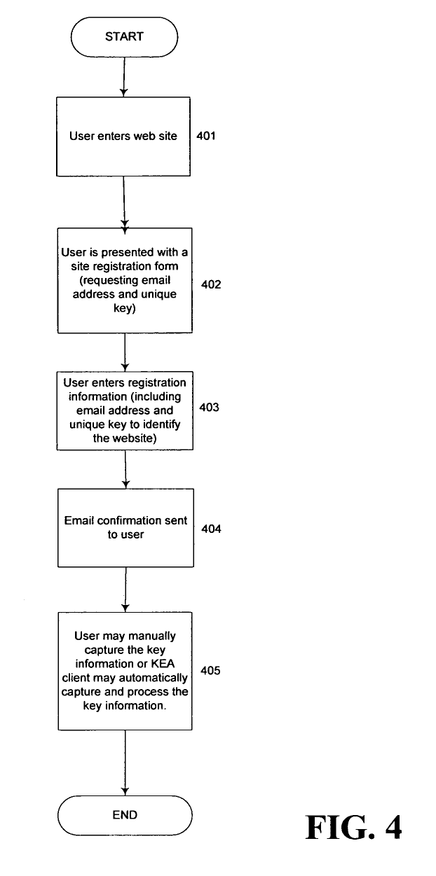

FIG. 4 is a flow chart illustrating an embodiment of the present invention. Although the following operations may be described as a sequential process, many of the operations may in fact be performed in parallel and/or concurrently. In addition, the order of the operations may be re-arranged without departing from the spirit of embodiments of the invention. As illustrated, in 401, a user may enter a website that requires registration. Assuming the website includes a KEA framework, the user may be requested to register in 402 via a registration form that requests both the user's email address as well as a unique key. In 403, the website may utilize the user's email address to send a confirmation email to the user wherein the confirmation email may include the unique key. In 404, the user may manually capture the key information (i.e., associate the key uniquely with the website's address) or the user's email account may be configured to automatically, capture and process the key information Thereafter, emails from this website may be accepted only if they include the unique key and the unique key may only be authenticated for emails originating from this website.

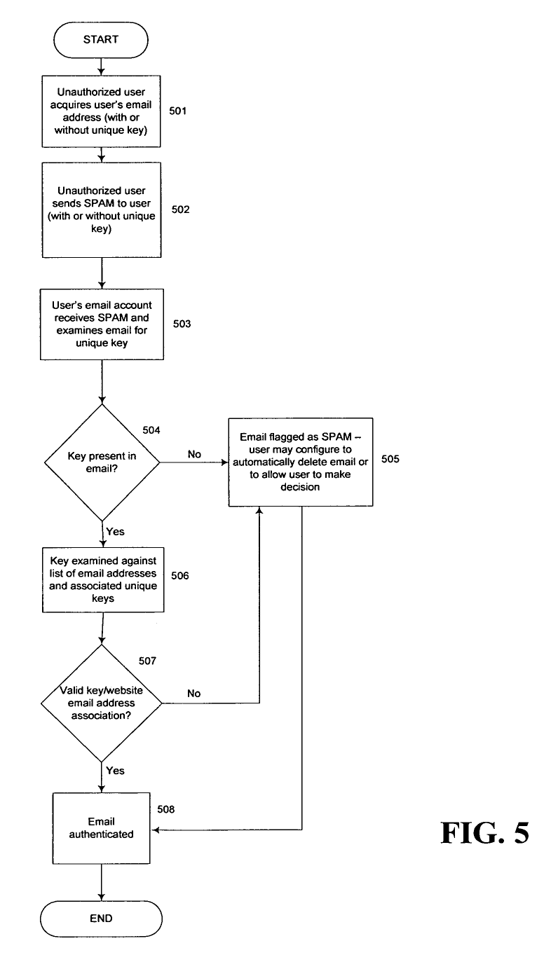

If the user's email address and/or unique key for the website thereafter fall into the hands of unscrupulous third parties, the user may nonetheless have additional protection against SPAM. FIG. 5 is a flow chart illustrating an embodiment of the present invention wherein an unauthorized third party attempts to send SPAM to the user. Again, although the following operations may be described as a sequential process, many of the operations may in fact be performed in parallel and/or concurrently. In addition, the order of the operations may be re-arranged without departing from the spirit of embodiments of the invention. In 501, the unauthorized third party may acquire the user's email address (with or without the unique key). The third party may thereafter utilize the information to send SPAM to the user in 502. In 503, the user's email account may receive the SPAM and examine the email for a key in 504. If a key does not exist in the email (e.g., if the spammer only acquired and/or used the user's email address without the unique key), the email may be flagged as SPAM in 505 (for processing as desired/configured by the user).

If, however, the key exists in 504, then in 506, the email account may examine the key and email address of the spammer against a list of associated keys maintained by the email account. In this case, although the key is a “real” key (i.e., one provided by the user to a website), the key nonetheless will not match the website address associated with it. In other words, since the spammer's email address will inevitably be different than the website email address, the website address/key authentication will fail when examined in 507 and the email may be flagged as SPAM in 505. If, however, the spammer is able to somehow “spoof” the website's email address, then the website address/key authentication may “pass” in 508 and the email may be authenticated as non-SPAM. The latter situation requires significantly more work on the part of spammer's, however, and as a result, the KEA framework on the website will still provide significantly reduced SPAM for the user because not all spammers will have the resources to take the extra step of spoofing a valid website. Additionally, in the event the spammers do take this extra step, upon receipt of the first email identified as SPAM from this email address (with a valid key), the user may easily identify and invalidate the key to prevent additional spamming.

Embodiments of the present invention may be implemented on a variety of computing devices. According to an embodiment, a computing device may include various other well-known components such as one or more processors. The processor(s) and machine-accessible media may be communicatively coupled using a bridge/memory controller, and the processor may be capable of executing instructions stored in the machine-accessible media. The bridge/memory controller may be coupled to a graphics controller, and the graphics controller may control the output of display data on a display device. The bridge/memory controller may be coupled to one or more buses. One or more of these elements may be integrated together with the processor on a single package or using multiple packages or dies. A host bus controller such as a Universal Serial Bus (“USB”) host controller may be coupled to the bus(es) and a plurality of devices may be coupled to the USB. For example, user input devices such as a keyboard and mouse may be included in the computing device for providing input data. In alternate embodiments, the host bus controller may be compatible with various other interconnect standards including PCI, PCI Express, FireWire and other such existing and future standards.

In the foregoing specification, the invention has been described with reference to specific exemplary embodiments thereof. It will, however, be appreciated that various modifications and changes may be made thereto without departing from the broader spirit and scope of the invention as set forth in the appended claims. The specification and drawings are, accordingly, to be regarded in an illustrative rather than a restrictive sense.

What is claimed is:

1. A method comprising:
examining an email from a sender to determine if the email includes an identifier;
if the email includes the identifier, examining the identifier to determine a status;
determining how to handle the email based on the status of the identifier; and
if the email does not include an identifier, following a first predetermined course of action.

2. The method according to claim 1 wherein following the predetermined course of action further comprises at least one of:
rejecting the email; and
responding to the sender with a request for the identifier.

3. The method according to claim 1 wherein the status of the identifier comprises one of valid, expired and new and:
if the status of the identifier is valid, the email is accepted;
if the status of the identifier is expired, performing at least one of one of rejecting the email and informing the sender that the email is being rejected; and
if the status of the identifier is new, following a second predetermined course of action.

4. The method according to claim 3 wherein the second predetermined course of action comprises at least one of:
rejecting the email; and
prompting a recipient whether to accept the email.

5. The method according to claim 4 wherein if the recipient accepts the email, the method comprises:
registering an email address of the email; and
generating a new identifier corresponding to the email address.

6. The method according to claim 6 wherein the email address comprises one of an individual address and a domain address.

7. The method according to claim 1 wherein the identifier is a key comprising at least one of a string of characters and a word.

8. A method, comprising:
providing a unique identifier during registration on a website;
capturing information pertaining to an address of the website and the unique identifier;
thereafter comparing any incoming email having the unique identifier against the captured information;
if the incoming email having the unique identifier includes the address of the website in the captured information, then opening the email; and
if the incoming email having the unique identifier includes an address other than the address of the website in the captured information, then following a predetermined course of action.

9. The method according to claim 8 wherein the predetermined course of action comprises at least one of:
rejecting the email; and
prompting a recipient whether to open the email.

10. A system, comprising:
a receiving email account; and
a key encryption (“KEA”) module communicatively coupled to the email account, the KEA module capable of:
generating unique identifiers;
examining an incoming email to determine if the incoming email includes an identifier;
if the incoming email includes the identifier, comparing the identifier in the incoming email against the generated unique identifiers to determine a status of the identifier; and
if the incoming email does not include an identifier, following a first predetermined course of action.

11. The system according to claim 10 wherein the KEA module is capable of following the first course of action by at least one of:
rejecting the incoming email; and
responding to a sender of the incoming email with a request for the identifier.

12. The system according to claim 11 wherein the KEA module is further capable of following a second predetermined course of action based on the status of the identifier, the second predetermined course of action comprising at least one of:
if the status of the identifier is valid, accepting the incoming email for viewing in the email account;
if the status of the identifier is expired, performing at least one of one of rejecting the incoming email and informing the sender that the incoming email is being rejected; and
if the status of the identifier is new, following a second predetermined course of action;

13. The system according to claim 10 wherein the KEA module is communicatively coupled to a recipient email system.

14. The system according to claim 10 wherein the KEA module is communicatively coupled to an enterprise email server.

15. An article comprising a machine-accessible medium having stored thereon instructions that, when executed by a machine, cause the machine to:
examine an email from a sender to determine if the email includes an identifier;
if the email includes the identifier, examine the identifier to determine a status;
determine how to handle the email based on the status of the identifier; and
if the email does not include an identifier, follow a first predetermined course of action.

16. The article according to claim 15 wherein the instructions, when executed by the machine, follow the predetermined course of action by at least one of:
rejecting the email; and
responding to the sender with a request for the identifier.

17. The article according to claim 15 wherein the instructions, when executed by the machine, determines the status of the identifier as including one of valid, expired and new:

18. The article according to claim 17 wherein the instructions, when executed by the machine, further cause the machine to:
if the status of the identifier is valid, accept the email;
if the status of the identifier is expired, perform at least one of one of rejecting the email and informing the sender that the email is being rejected; and
if the status of the identifier is new, follow a second predetermined course of action;

19. The article according to claim 18 wherein the instructions, when executed by the machine, further cause the machine to follow the second predetermined course of action comprising at least one of:
rejecting the email; and
prompting a recipient whether to accept the email.

20. The article according to claim 19 wherein instructions that, when executed by the machine cause the recipient to accept the email further comprises instructions that, when executed by the machine:
registers the email address; and
generates a new identifier corresponding to the email address;
